(19) United States
(12) Patent Application Publication
(10) Pub. No.: US 2005/0206910 A1
(43) Pub. Date: Sep. 22, 2005

(54) Linear displacement sensor

(76) Inventors: Richard A. Schroeder, Oxford, MI (US); Joe A. Turner, Troy, MI (US); Christopher J. Torchala, Macomb Twp., MI (US)

Correspondence Address: BRINKS HOFER GILSON & LIONE, P.O. BOX 10395, CHICAGO, IL, 60610, US

(21) Appl. No.: 10/804,327

(22) Filed: Mar. 19, 2004

(51) Int. Cl. G01B 11/14

(52) U.S. Cl. 356/614

(57) ABSTRACT

A linear displacement sensor includes a plurality of nested, telescoping sections extending between two end pieces. One end piece includes a light source such as an infrared light emitting diode (emitter), and the other end includes a light sensitive device such as a phototransistor (receiver). At least one disk having a centrally disposed aperture is secured to one of the sections and reduces and limits stray or incident light within the sensor which is reflected inside the sensor and would otherwise impinge upon the receiver. Improved accuracy and linearity is provided by this device.

### BACKGROUND OF THE INVENTION

The invention relates generally to displacement sensors and more particularly to displacement sensors having a telescoping body with a radiation source at one end and a radiation sensor at the other.

Measurement of the distance or displacement between two points in real time may be achieved by a wide variety of sensors. One of the oldest linear sensors utilizes a resistive element having a sliding electrical contact. The resistive element is secured to one member and the contact is secured to the other member. As the members translate relative to one another, the resistance or voltage output varies and indicates the present sensed position. Today, many different designs utilizing moving magnetic or electromagnetic members, Hall Effect sensors and optical devices provide accurate and repeatable translation and position sensing.

Optical devices utilizing a radiation source such as an LED and a radiation or light sensitive receiver such as a phototransistor are also capable of distance measurement. These, as well as many other sensors, operate on the physical principal that the intensity of a radiation beam diminishes or increases with the square of the distance between the source and the sensor. Optical displacement sensors thus have a distinct advantage in that no mechanical connection need be present between the two members or features between which distance is being sensed. However, the device must be configured and the sensor must be mounted such that it is not subjected to incident or any light other than the direct light beam emitted by the radiation source. The lack of mechanical connection between the sensed elements or feature makes an optical sensor particularly attractive for sensing displacement in anthropomorphic test dummies (ATDs) also known as crash test dummies because of the rapid, though somewhat limited translation. The present invention is directed to an optical sensor for use in such devices.

### BRIEF SUMMARY OF THE INVENTION

A linear displacement sensor includes a plurality of nested, telescoping sections extending between two end pieces. One end piece includes a light source or emitter such as an infrared light emitting diode (LED), and the other end includes a light sensitive device or receiver such as a phototransistor. At least one disk having a centrally disposed aperture is secured to one of the sections and reduces and limits stray or incident light within the sensor which may be reflected inside the sensor and impinge upon the receiver. Improved accuracy and linearity is provided by this device.

Thus it is an object of the present invention to provide an optical linear displacement sensor having a radiation source spaced from a radiation sensor and enclosed within a telescoping housing.

It is a further object of the present invention to provide an optical linear displacement sensor having radiation source and radiation sensor configured within a housing which minimizes the measurement of stray or incident light from the radiation sensor.

It is a still further object of the present invention to provide an optical displacement sensor having a radiation source, a radiation sensor disposed within a telescoping housing and at least one disk having an aperture disposed between said source and sensor.

Further objects and advantages of the present invention will become apparent by reference to the following description of the preferred embodiment and appended drawings which in like reference numbers refer to the same component, element or feature.

### BRIEF DESCRIPTION OF THE DRAWINGS

FIG. 1 is a fragmentary perspective view of the ribcage portion of an anthropomorphic test dummy utilizing the present invention;

FIGS. 2A and 2B are exploded views of a linear displacement sensor according the present invention;

FIG. 3 is a full, sectional view of a linear displacement sensor according to the present invention; and

FIG. 4 is a full, sectional view of a completely telescoped linear displacement sensor according to the present invention.

### DETAILED DESCRIPTION OF THE INVENTION

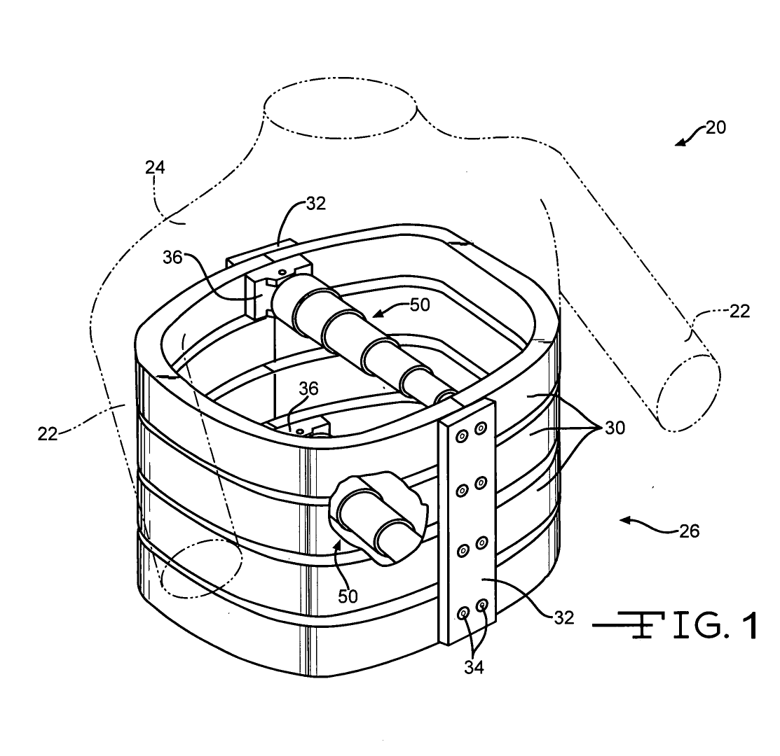

Referring now to FIG. 1, an upper torso portion of an anthropomorphic test dummy (ATD) is illustrated and generally designated by the reference number 20. The upper torso portion 20 includes left and right arms 22 which may be covered and defined by a resilient, elastic covering 24 such as a silicone rubber. The upper torso portion 20 also includes a ribcage assembly 26 as well as other components and assemblies (not illustrated) simulating a human torso. The upper torso portion 20 may be scaled to simulate adults, adolescents, children, toddlers or infants.

The ribcage assembly 26 includes a plurality of generally circular or oval, two piece rib assemblies 30 which may be secured together, for example, at their front and rear by vertical bars 32 and suitable threaded fasteners 34. Within the interior of the ribcage assembly 36 are disposed mounting blocks 36 which receive and secure a pair of linear displacement sensor assemblies 50 according to the present invention within the ribcage assembly 26. The linear displacement sensor assemblies 50 provide information in real time regarding the relative front to back displacement or compression of the rib assemblies 30 as they undergo movement during a crash test. At the outset, it should be understood that while the linear displacement sensor assemblies 50 are illustrated within an anthropomorphic test dummy ribcage, the assembly 50 has wide application as a linear displacement sensor and the following description is intended to be illustrative and exemplary only.

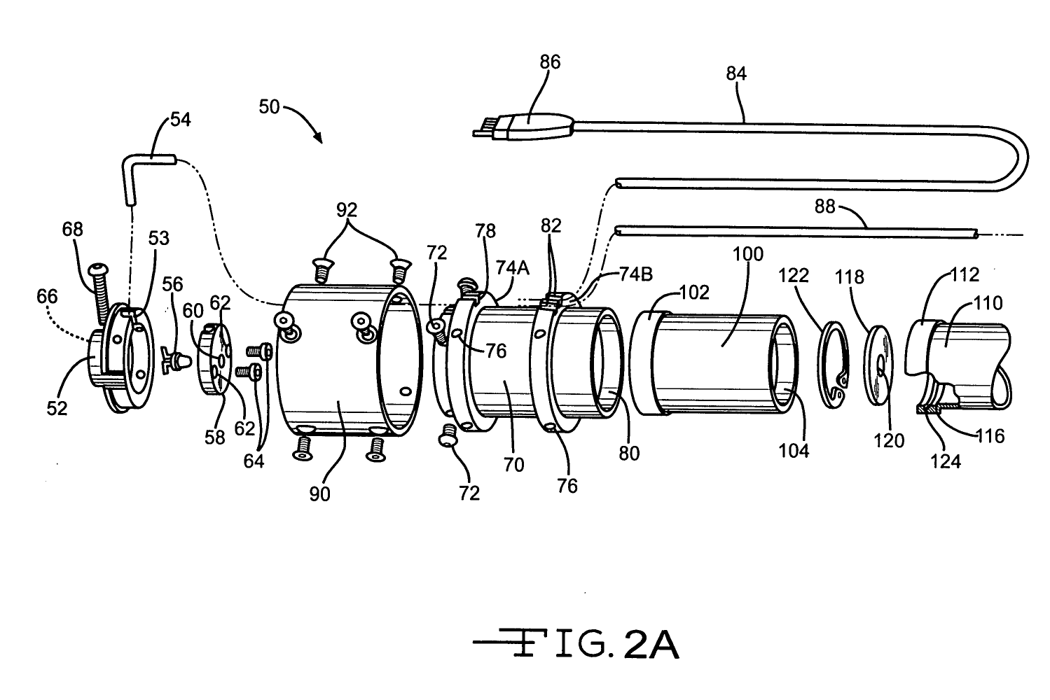

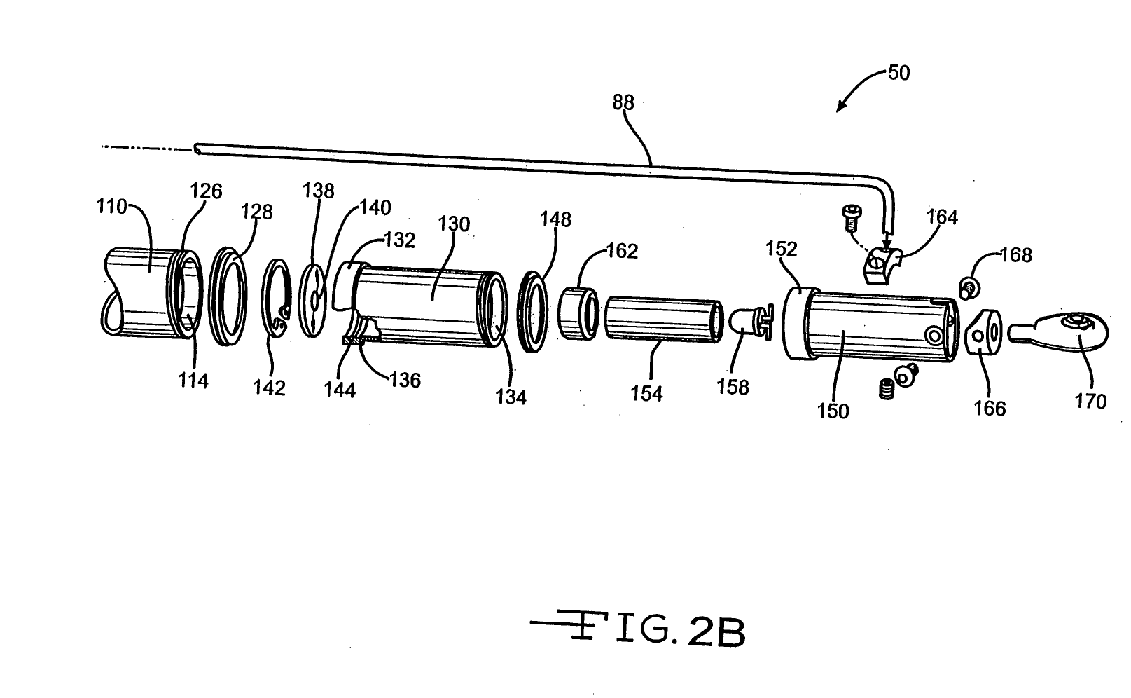

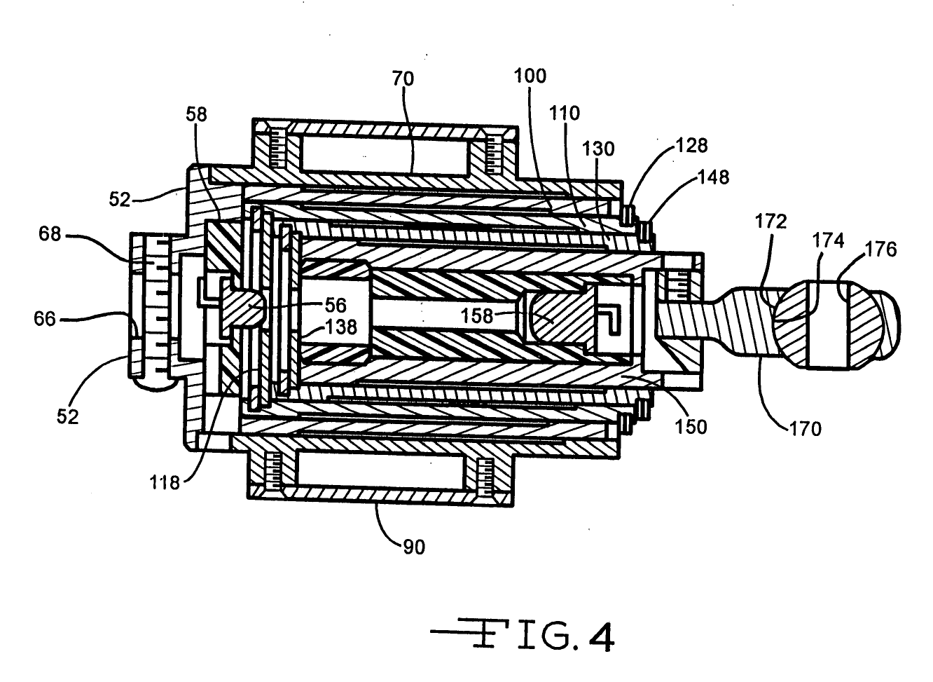

Referring now to FIGS. 2A and 2B, the linear displacement sensor assembly 50 includes a first or rear end cap 52 having a radial slot 53 which receives an electrical cable 54 which provides electricity to an infrared light emitting diode (LED) 56. The light emitting diode 56 is retained within the rear end cap by a cover or disk 58 having a diode receiving opening 60 as well as openings 62 for receiving threaded fasteners 64 which seat within rear end cap 52. A blind aperture 66 is adapted to receive a complementarily sized pin or stub shaft (both not illustrated) extending from one of the rib assemblies 20 illustrated in FIG. 1 which may be secured to the end cap 52 by a set screw 68, illustrated in FIG. 4.

The rear end cap 52 and associate components are received within a main housing or first cylindrical section 70 and retained thereby a plurality of radially oriented fasteners 72. The main housing or first cylindrical section 70 includes a pair of spaced apart collars 74A and 74B, which are preferably integrally formed with the first section 70 and include a plurality of such threaded openings 76. The first collar 74A includes a single longitudinal slot 78 which receives the electrical cable 54. The second collar 74B includes two longitudinal slots 82 which receive a first power and signal cable 84 having a suitable multiple conductor connector 86 as its termination and a second electrical cable 88. A cylindrical cover 90 defines an inside diameter just slightly larger than the outside diameter of the collars 74A and 74B and fits thereover. The axial space between the collars 74A and 74B may be occupied by electronic components, circuit boards and the like (not illustrated) which drive and process signals to and from the radiation source and sensor. These components form no portion of the present invention. The cylindrical cover 90 is maintained in place upon the main housing or first cylindrical section 70 by a plurality of radially oriented set screws or threaded fasteners 92 received within the threaded openings 76. The main housing or first section 70 includes a first shoulder 80 on its inner surface opposite the rear end cap 52.

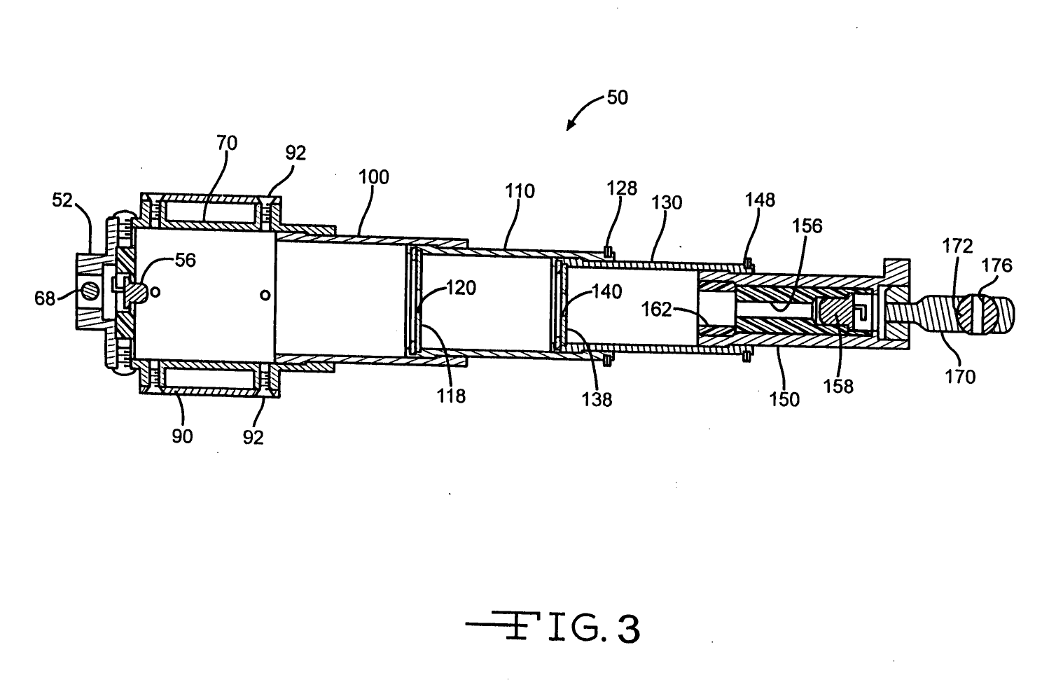

As illustrated in FIG. 3, axially, slidably and telescopingly received within the first section 70 is a second tubular or cylindrical section 100. The second section 100 includes an enlarged diameter second end region or flange 102 which has a diameter just slightly less than the inside diameter of a major portion of the axial length of the first cylindrical section 70 but which interferes with the first shoulder 80. Similarly, the second section 100 includes a second shoulder 104 which slightly reduces the inside diameter of the second section 100 at its end opposite the rear end cap 52.

Disposed axially, slidingly and telescopingly within the second section 100 is a third cylindrical section 110. The third cylindrical section 110 includes a third enlarged diameter end region or flange 112 which has an outside diameter just slightly less than the inside diameter of a major portion of the second section 100 but which interferes with the second shoulder 104 therein. The third cylindrical section 110 likewise includes a third interior shoulder 114 on the inner surface of the third section 110 at its end opposite the rear end cap 52. The third cylindrical section 110 also includes a shoulder or step 116 against which a first plate or disk 118 having a first circular aperture or orifice 120 is received.

The first aperture or orifice 120 preferably has a diameter approximately equal to the diameter of the infrared light emitting diode 56 and preferably just slightly larger than the diameter of the beam emitted by the light emitting diode 56. A nominal diameter of 0.19 inches (4.83 mm) has been found suitable. It should be appreciated that smaller diameter, though increasingly reducing or eliminating any stray or incident light within the sensor 50, may themselves affect the intensity of axially transmitted light passing therethrough which, of course, is unacceptable. Larger diameter apertures 120 will have a diminishing impact upon such axially transmitted light but may, as their diameter increases, permit increasing transmission of angular or oblique stray or incident light which is objectionable. Again, the diameter of the light source, i.e., the light emitting diode 56 or the diameter of its light beam, are the best guides for determining the diameter of the first aperture or orifice 120. The range of 0.15 inches to 0.25 inches (3.81 mm to 13.1 mm) will encompass a typical range of diameters of the first aperture or orifice 120 for commonly sized and encountered light emitting diodes such as the diode 56 and the associated light beam.

A conventional snap ring 122 retains the first disk 118 in position against the shoulder or step 116 in the end of the third section 110 as it is received within a circumferential channel 124. On the outside of the third cylindrical section 110, proximate the end having the interior shoulder 114, is a circumferential groove 126 which receives a snap ring, a multiple turn shop ring, a wave washer or a similar retaining device 128. The snap ring 128 limits the axial travel of the third section 110 into the second section 100 as will be readily appreciated.

Disposed axially, slidingly and telescopingly within the third cylindrical section 110 is a fourth cylindrical section 130. The fourth cylindrical section 130 includes an enlarged diameter fourth end region or flange 132 which has an outside diameter just slightly less than the inside diameter of a major portion of the third section 110 but which interferes with the third shoulder 114 therein. The fourth cylindrical section 130 likewise includes an interior shoulder or flange 134 on the inner surface of the fourth section 130 at its end opposite the rear end cap 52. The fourth cylindrical section 130 also includes a shoulder or step 136 against which a second plate or disk 138 having a second circular aperture or orifice 140 is received. The second aperture or orifice 140, like the first aperture or orifice 120 preferably has a diameter approximately equal to the diameter of the infrared light emitting diode 56 or just slightly larger than the diameter of the beam emitted by the light emitting diode 56 and just slightly smaller than the first aperture or orifice 120. A nominal diameter of 0.18 inches (4.57 mm) has been found suitable.

It should be appreciated that smaller diameter apertures 140, though increasingly reducing or eliminating any stray or incident light within the sensor 50 may themselves affect the intensity of axially transmitted light which is unacceptable. Larger diameter apertures 140 will have a diminishing impact upon the axially transmitted light, but may, as their diameter increases, permit increasing angularly or obliquely transmitted stray or incident light which is objectionable. Once again, the diameter of the light source, i.e., the light emitting diode 56 or the diameter of its light beam, are the best guides to determining the diameter of the second aperture or orifice 140. The range of 0.14 inches to 0.23 inches (3.56 mm to 5.8 mm) will thus typically encompass a useful range of diameters of the second aperture or orifice 140 for commonly sized and encountered light emitting diodes, such as the diode 56 and the associated light beam.

A conventional snap ring 142 retains the disk 138 in position against the shoulder 136 and the end of the fourth cylindrical section 130 as it is received within the circumferential channel 144. On the fourth cylindrical section 130, proximate its end having the interior shoulder 134 is a circumferential groove 146, a multiple turn snap ring, a wave washer or similar retaining device which receives a snap ring 148. The snap ring 148 limits axial travel of the fourth cylindrical section 130 into the third cylindrical section 110.

Lastly, the sensor assembly 50 includes a fifth section 150 which is again tubular or cylindrical and includes an enlarged diameter end region or flange 152 which has an outside diameter just slightly less than the major portion of the inside diameter of the fourth cylindrical section 130 and which interferes with the fourth shoulder 134 therein. Disposed within the fifth cylindrical section 150 is a tubular mount 154 having a stepped interior passageway 156 illustrated in FIG. 3, which receives and restrains photo detector or a light sensitive transducer such as a phototransistor 158. The tubular mount 154 is received within the fifth cylindrical section 150 and retained thereby an annular collar 162. The electrical cable 88 is connected to the output terminals of phototransistor 158 and a cable clamp 164 secures same to the fifth cylindrical section 150. An internal end plug 166 is received within the open end of the fifth cylindrical section 150 and retained thereby suitable fasteners 168. Secured to the end plug 166 is a ball joint assembly 170 which may be utilized to attach the sensor assembly 50 to one component of a device such as the rib assembly 20, illustrated in FIG. 1. The ball joint assembly 170 includes a spherical bearing 172 received within a complementarily configured race or retainer 174. A through passageway 176 in the spherical bearing 172 facilitates attachment of the ball joint assembly 170 to, for example, one of the rib assemblies 20, as noted above.

Although the foregoing description relates to a linear displacement sensor 50 having five telescoping sections, it should be appreciated that a sensor having two, three, four, six or more telescoping sections is fully within the ambit of this invention as the invention is readily useable with devices having essentially any number of sections. The choice of the number of telescoping sections will typically be affected by the nominal initial and final distances between the components to be sensed, the difference between the open and closed or collapsed positions of the components and the space, i.e., transverse dimensions available for the sensor. Furthermore, while the use of two aperture disks has been found to achieve excellent operation, significant improvement in measurement accuracy will be achieved by the use of a single aperture disk (relative to not using any aperture disks) and more than two disks may be used if desired. If a single aperture disk is utilized, preferably it will be located at (or near) and remain at (or near) the mid-point between the radiation emitter and receiver during operation.

It should also be noted that radiation sensors other than light emitting diodes and sensors other than phototransistors may be utilized in the disclosed invention. Finally, given the high linear measurement accuracy, repeatability and hysteresis of the disclosed linear displacement sensor assembly 50, it will be appreciated that it will have broad application beyond anthropomorphic test dummies and be useable in any application requiring its capabilities.

The foregoing disclosure is the best mode devised by the inventors for practicing this invention. It is apparent, however, that devices incorporating modifications and variations will be obvious to one skilled in the art of displacement sensors and more particularly to displacement sensors having a telescoping body with a radiation source at one end and a radiation sensor at the other. Inasmuch as the foregoing disclosure is intended to enable one skilled in the pertinent art to practice the instant invention, it should not be construed to be limited thereby but should be construed to include such aforementioned obvious variations and be limited only by the scope and spirit of the following claims.

1. A linear displacement sensor comprising, in combination,
a first end having a source of radiation,
a second end having a receiver sensitive to such radiation,
a telescoping housing extending between said first end and said second end, said housing having at least a first larger section and a second, smaller section disposed within said first section, and
a plate disposed within said housing and defining an aperture,
whereby said aperture transmits direct radiation and reduces transmission of incident radiation.

2. The linear displacement sensor of claim 1 wherein said housing has three sections.

3. The linear displacement sensor of claim 1 wherein said housing has five sections.

4. The linear displacement sensor of claim 1 wherein said housing includes means for securing to two components to be measured.

5. The linear displacement sensor of claim 4 wherein said means for securing includes a ball joint.

6. The linear displacement sensor of claim 1 further including a second plate defining a second aperture.

7. The linear displacement sensor of claim 6 wherein said apertures have distinct diameters.

8. A linear displacement sensor comprising, in combination,
a first end having a source of radiation,
a second end having a receiver sensitive to such radiation,
a telescoping housing extending between said first end and said second end, said housing having at least a first larger diameter section and a second, smaller diameter section disposed within said first section, and
a disk disposed within said housing and defining a central aperture,
whereby said aperture passes a direct radiation and reduces passage of incident radiation.

9. The linear displacement sensor of claim 8 wherein said housing has three sections.

10. The linear displacement sensor of claim 8 wherein said housing has five sections.

11. The linear displacement sensor of claim 8 wherein said housing includes means for securing to two components to be measured.

12. The linear displacement sensor of claim 11 wherein said means for securing includes a ball joint.

13. The linear displacement sensor of claim 8 further including a second plate defining a second aperture.

14. The linear displacement sensor of claim 13 wherein said apertures have distinct diameters.

15. A linear displacement sensor comprising, in combination,
a telescoping body having at least a first hollow section and a first closed end and a second section slidably disposed within said first section and having a second closed end,
a radiation source disposed in one of said closed ends and a radiation receiver disposed in another of said closed ends to receive radiation from said radiation source, and
at least one disk disposed between said radiation source and said radiation receiver having an aperture for passing radiation from said radiation source.

16. The linear displacement sensor of claim 15 wherein said radiation source is a light emitting diode.

17. The linear displacement sensor of claim 15 wherein said radiation receiver is a phototransistor.

18. The linear displacement sensor of claim 15 wherein said radiation source generates a beam of radiation and said aperture has a diameter approximately equal to said beam of radiation.

19. The linear displacement sensor of claim 15 wherein said telescoping body has at least five sections.

20. The linear displacement sensor of claim 15 wherein said telescoping body includes means for attaching devices to be measured.
